(19) United States
(12) Patent Application Publication
(10) Pub. No.: US 2010/0295731 A1
(43) Pub. Date: Nov. 25, 2010

(54) METHOD FOR OPTIMUM BANDWIDTH SELECTION OF TIME-OF-ARRIVAL ESTIMATORS

(76) Inventors: Chia-Chin Chong, Santa Clara, CA (US); Fujio Watanabe, Union City, CA (US)

Correspondence Address: Haynes and Boone, LLP;IP Section, 2323 Victory Avenue, SUITE 700, Dallas, TX, 75219, US

(21) Appl. No.: 11/963,630

(22) Filed: Dec. 21, 2007

Related U.S. Application Data
(60) Provisional application No. 60/884,569, filed on Jan. 11, 2007.

(51) Int. Cl. G01S 1/24

(52) U.S. Cl. 342/387

(57) ABSTRACT

A method determines an optimum bandwidth that minimizes ranging error in a geolocation application. The method ensures that an optimum bandwidth is selected under all channel conditions (i.e., both line-of-sight (LOS) and non-LOS (NLOS) conditions). Additionally, the method is generic and system-independent, such that it is applicable to both coherent receivers (e.g., match filter (MF) based receivers), non-coherent receivers (e.g., energy detector (ED) based receivers) and any types of time-of-arrival (TOA) estimators (e.g., whether peak-detection or threshold-based TOA estimator), regardless of the signal-to-noise ratios (SNRs) under consideration.

### CROSS-REFERENCE TO RELATED APPLICATIONS

The present application is related to and claims priority of copending U.S. provisional patent application (the “'569 Provisional Application”), Ser. No. 60/884,569, entitled “Method for Optimum Bandwidth Selection of Time-of-Arrival Estimators,” filed on Jan. 11, 2007. The copending '569 Provisional Application is hereby incorporated by reference in its entirety.

### BACKGROUND OF THE INVENTION

1. Field of the Invention

The present invention relates to ranging applications in a mobile communication system. In particular, the present invention relates to bandwidth selection in a mobile application to reduce ranging error computed based on time-of-arrival estimators.

2. Discussion of the Related Art

The need for accurate geolocation has intensified in recent years, especially for cluttered environments (e.g., inside buildings, in urban locales, and foliage), where the Global Positioning System (GPS) is often inaccessible. An unreliable geolocation hinders many applications, such as commercial inventory tracking in warehouses or cargo ships, and in military “blue force tracking” applications (i.e., locating friendly forces). Ultra-wideband (UWB) technology offers great potential for achieving high positioning accuracy in such cluttered environments due to its ability to resolve multipath and to penetrate obstacles. Examples of using UWB technology for geolocation are discussed in (a) “Ultra-wideband precision asset location system,” by R. J. Fontana and S. J. Gunderson, published in Proc. of IEEE Conf on Ultra Wideband Systems and Technologies (UWBST), Baltimore, Md., May 2002, pp. 147-150; (b) “An ultra wideband TAG circuit transceiver architecture,” by L. Stoica, S. Tiuraniemi, A. Rabbachin and I. Oppermann, published in International Workshop on Ultra Wideband Systems. Joint UWBST and IWUWBS 2004., Kyoto, Japan, May 2004, pp. 258-262; (c) “Pseudo-random active UWB reflectors for accurate ranging,” by D. Dardari, published in IEEE Commun. Lett., vol. 8, no. 10, pp. 608-610, October 2004; (d) “Localization via ultrawideband radios: a look at positioning aspects for future sensor networks,” by S. Gezici, Z. Tian, G B. Giannakis, H. Kobayashi, A. F. Molisch, H. V. Poor, and Z. Sahinoglu, published in IEEE Signal Processing Mag., vol. 22, pp. 70-84, July 2005; and (e) “Analysis of wireless geolocation in a non-line-of-sight environment,” by Y. Qi, H. Kobayashi, and H. Suda, published in IEEE Trans. Wireless Commun., vol. 5, no. 3, pp. 672-681, March 2006.

In a localization system based on the UWB technology, the time-of-arrival (TOA) technique is often used because of the fine time resolution that can be achieved using UWB signals. However, ranging accuracy is limited by the presence of noise, multipath components (MPCs), the effect of system bandwidth, and the presence of non-line-of-sight (NLOS) conditions. To achieve a higher ranging accuracy, a communication system may provide the transmitted signal a bandwidth larger than its symbol rate. Therefore, many TOA estimators that required high ranging accuracy use a higher operation bandwidth. The Nyquist-Shannon sampling theorem¹ requires that a band-limited signal be sampled at or higher than the Shannon or Nyquist rate. Therefore, in the TOA estimators, as the system bandwidth increases, a higher sampling rate is required, which increases the computational complexity and power consumption of the digital UWB receivers (RXs). However, as many applications impose constraints on device complexity and power consumption, a suitable trade-off between RX complexity and operating bandwidth is desired in order to achieve good ranging accuracy.

The article “Modeling of the distance error for indoor geolocation” (“Δlavi I”), by B. Alavi and K. Pahlavan, published in Proc. IEEE Wireless Commun. and Networking Conf, vol. 1, New Orleans, LO, March 2003, pp. 668-672, introduces a term normalized distance error, g, given by g=e_{d}/d , where e_{d} is the distance error defined as the difference between the measured distance \hat{d} between a transmitter (TX) and a RX, and the actual distance d. In Alavi I, a ray-tracing software tool is used to generate the database that is used to perform the analysis. The authors found that g has characteristics that are significantly different under a line-of-sight (LOS) condition as under an obstructed-LOS (OLOS) condition. For a LOS condition, g can be modeled satisfactorily by a zero-mean Gaussian distribution, while for an OLOS condition, a mixture of two distributions—a zero mean Gaussian distribution and an exponential distribution—is required.

In the article, “Bandwidth effect on distance error modeling for indoor geolocation” (“Alavi II”) also by B. Alavi and K. Pahlavan, published in Proc. IEEE Int. Symp. on Personal, Indoor and Mobile Radio Commun., vol. 3, Beijing, China, September 2003, pp. 2198-2202, the authors extend their work to the effect of system bandwidth (w) on the normalization distance error g under both LOS and OLOS conditions. As in Alavi I, the zero-mean Gaussian distribution and the mixture of Gaussian and exponential distributions are used in Alavi II to model g under LOS and OLOS conditions, respectively. Additionally, Alavi II proposes a polynomial equation to model the variation in the standard deviation s_{g} of the zero-mean Gaussian distribution. In Alavi II, standard deviation s_{g} is provided as a function of bandwidth for both LOS and OLOS conditions. For the OLOS condition, the mean l_{g} of the exponential distribution, is assumed to be constant over bandwidth. In both Alavi I and Alavi II, a ray-tracing tool generates the database for the distance error modeling. Their models are based on partitioning the area into LOS and OLOS conditions. However, the validity of the models of Alavi I and Alavi II for UWB applications may be limited.

In subsequent articles by these authors: (a) “Indoor geolocation distance error modeling using UWB channel measurements” (“Alavi III), in Proc. IEEE Int. Symp. on Personal, Indoor and Mobile Radio Commun., vol. 1, Berlin, Germany, September 2005, pp. 481-485; and (b) “Modeling of the TOA-based distance measurement error using UWB indoor radio measurements” (“Alavi IV”), published in IEEE Commun. Letter, vol. 10, no. 4, pp. 275-277, April 2006, the authors extend their model for the distance error by considering an UWB system having a bandwidth that varies from 3-6 GHz. In Alavi III and Alavi IV, the authors present measurements taken from an office environment, instead of a ray-racing simulation. Furthermore, the models of Alavi III and Alavi IV are not based on partitioning the application area into LOS and OLOS conditions. Instead, the concepts of detected direct path (DDP) and undetected direct path (UDP) are introduced. To take into account DDP and UDP, the distance error (e_{d}) is modeled to have two parts: (a) a multipath error (eₘ), and a UDP error (eᵤ). The multipath error relates to multipath dispersion and the UDP error relates to occurrence of the UDP condition. Alavi III and Alavi IV analyzed these errors with respect to the system bandwidth. The multipath error is present under both DDP and UDP conditions, while the UDP error is present occasionally and usually under a UDP condition. Both eₘ, and eᵤ can be modeled by Gaussian distributions with the resulting distance error being characterized by a mixture of two Gaussian distributions. The probability of an UDP condition increases (hence, correspondingly, a UDP error probability increases) with both distance and bandwidth. However, an increase in bandwidth reduces the multipath error. Therefore, an optimum system bandwidth reduces the distance error. However, such an optimization is discussed in neither Alavi III nor Alavi IV.

In the article “Studying the effect of bandwidth on performance of UWB positioning systems” (“Alavi V”), published in Proc. IEEE Wireless Commun. and Networking Conf., vol. 2, Las Vegas, Nev., April 2006, pp. 884-889, the results of Alavi III and IV are extended by studying the effect of bandwidth on multipath error eₘ, and UDP error eᵤ separately, as well as in combination. Alavi V reports that, at a low bandwidth, multipath error eₘ, is dominant, while at a high bandwidth, UDP error eᵤ is dominant. Even though increasing the bandwidth decreases multipath error eₘ, an increase in bandwidth also increases UDP error eᵤ. Therefore, an optimum bandwidth is also required to reduce the overall error. Based on the UWB measurement database in an indoor office environment, Alavi V found that a best choice bandwidth at 2 GHz.

In the article, “Performance of TOA estimation algorithms in different indoor multipath conditions” (“Alsindi”), by N. Alsindi, X. Li and K. Pahlavan, published in Proc. IEEE Wireless Commun. and Networking Conf., vol. 1, Atlanta, Ga., March 2004, pp. 495-500, the authors provide a performance analysis, comparing different TOA estimation algorithms under different environments (i.e., LOS, OLOS, DDP, NDDP and UDP conditions) and bandwidths. The TOA estimation algorithms compared are inverse Fourier transform (IFT), direct sequence spread spectrum (DSSS) and super-resolution Eigenvector (EV) algorithms. Under an LOS condition, at lower bandwidths, the more complex EV algorithm performs slightly better than IFT, but almost the same as DSSS. Under an LOS condition, at higher bandwidths, no significant advantage is found in any of the three algorithms compared. Under an OLOS condition, the EV algorithm significantly improves the TOA estimation and outperforms both IFT and DSSS across all bandwidths. Therefore, under an OLOS condition, more complex TOA estimation algorithms reduce the error to an acceptable level. Under an NDP condition, substantial errors are introduced by a UDP condition, even with an increased bandwidth for the system and with the use of a complex TOA estimation algorithm Thus, to reduce distance error, an understanding of channel condition is critical prior to choosing a TOA estimator and the bandwidth to be used. Alsindi did not investigate an optimum operating bandwidth that reduces the estimation error for each TOA estimator.

TOA radio location systems are limited in ultimate accuracy by both signal-to-noise ratio (SNR) and the time-varying multipath environment in which they must operate. U.S. Pat. No. 5,742,635 (“Sanderford”), to H. B. Sanderford, Jr., entitled “Enhanced time of arrival method,” issued on Apr. 21, 1998, discloses a technique which can maintain a high SNR by identifying a feature of the received signal that is least affected by multipath. The identification is achieved by increasing or reducing the system bandwidth according to channel conditions in order to lower the noise floor. The technique uses correlation peak information to estimate the leading edge of the correlation function, then enhances discrete samples at the leading edge of the correlation function to yield high SNR readings. However, Sanderford's technique starts with a very high bandwidth and reduces the bandwidth accordingly to enhance both the SNR and a high ranging accuracy. Such a technique requires both a high sampling rate and adaptive circuitry that changes the bandwidth in a very fast manner, which results in a high implementation cost. To implement a cost effective system, a positioning system with optimum bandwidth that can provide optimum ranging accuracy is therefore highly desired. Sanderford, however, does not disclose a way to determine the optimum bandwidth required to operate under certain channel conditions.

### SUMMARY

According to one embodiment of the present invention, an optimum bandwidth selection method is provided for generic TOA estimators. The critical design parameters that affect optimal bandwidth selection are the multipath fading, SNR (or TX-RX separation distance), and NLOS propagation. A method according to the present invention relates the effects of these parameters to determine an optimum bandwidth for a generic TOA estimator, thereby reducing the ranging error.

The present invention provides methods that are generic and system-independent (i.e., applicable to both coherent and non-coherent systems) and may be applied to any type of TOA estimators (e.g., peak-detection estimators and threshold-based estimators) irrespective of SNR values. Further, the effects of multipath and NLOS propagation errors are accounted for and the bandwidth selection method is particularly applicable to dense multipath UWB communication applications.

An appropriately selected bandwidth can lower the required sampling rate, such that reduced computational requirements are achieved, relative to the prior art, thus allowing slower analog-to-digital (A/D) converters to be used, thereby significantly reducing power consumption of digital receivers, which also effectively lower production costs of such receivers. By always choosing an optimum bandwidth, resources can be used efficiently, using only the necessary bandwidth amount without redundancy. Excess bandwidth spent merely for locating a wireless device does not yield significant benefits and constitutes a waste of resource. Thus, enlarging the system bandwidth only increases the implementation complexity of the UWB systems, while obtaining only a small improvement in ranging accuracy. Furthermore, the present invention provides an effective figure of merit for deciding the receiver bandwidth requirements for accurate wireless device location estimation.

Since the bandwidth selection method of the present invention is generic (i.e., such a method is applicable to coherent and non-coherent systems, as well as to any types of TOA estimators (e.g., peak-detection and threshold-based)), the method may be used in many localization application-based systems. The method of the present invention uses the channel conditions (i.e., LOS or NLOS) to choose the optimum bandwidth that minimize the ranging error, irrespective of the transceiver separation distance (i.e., SNR).

The present invention is better understood upon consideration of the detailed description below, in conjunction with the accompanying drawings.

### BRIEF DESCRIPTION OF THE DRAWINGS

FIG. 1 shows a typical multipath channel impulse response.

FIG. 2 shows coherent system 200 for estimating the TOA based on match filter (MF), in accordance with one embodiment of the present invention.

FIG. 3 shows non-coherent system 300 for estimating the TOA based on energy detector (ED), in accordance with one embodiment of the present invention.

FIG. 4 shows one implementation of TOA estimator 400 of FIG. 2, which can be based either on peak-detection TOA estimator 500 or threshold-based TOA estimator 600.

FIG. 5 shows Single Search (SS) scheme 502, Search and Subtract (SaS) scheme 504, and Search, Subtract and Readjust (SSaR) scheme 506 suitable for implementing peak-detection TOA estimator 500 of FIG. 5.

FIG. 6 illustrates threshold-based TOA estimator 600 suitable for implementing threshold-based TOA estimator for both the coherent and non-coherent systems, according to one embodiment of the present invention.

FIG. 7 illustrates the effects of both multipath dispersion and system bandwidth on the first arriving path estimation.

FIG. 8 shows flowchart 800 of a method for selecting an optimum bandwidth for both LOS and NLOS conditions.

### DETAILED DESCRIPTION OF THE PREFERRED EMBODIMENTS

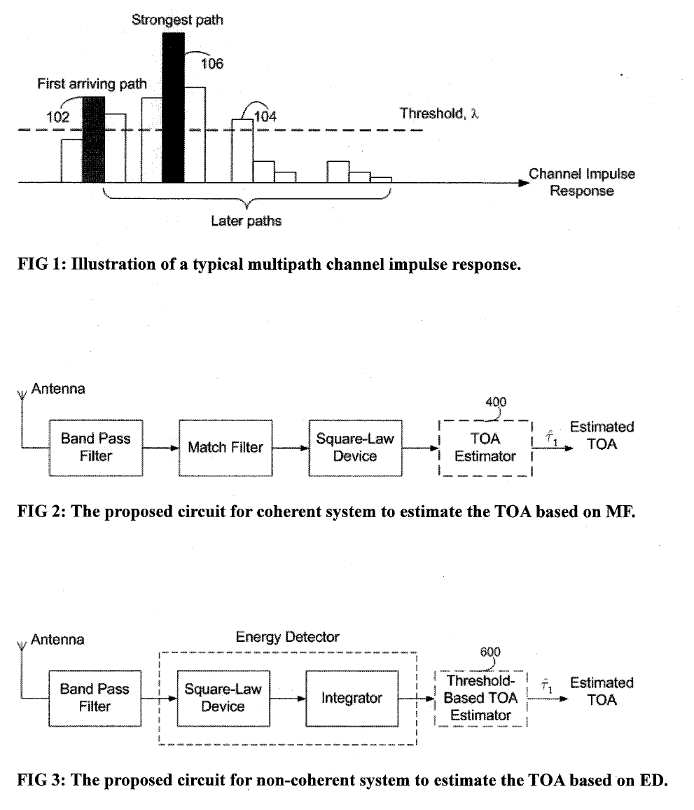

FIG. 1 shows a typical multipath channel impulse response. U.S. provisional patent application (“the '526 Provisional Application”), Ser. No. 60/868,526, entitled “Method for Optimum Threshold Selection of Time-of-Arrival Estimators,” filed on 4 Dec. 2006, discloses that, for geolocation purposes, the first arriving path (i.e., path 102 of FIG. 1), and not the later arrivals 104 (including the strongest path 106) is more significant to the ranging system accuracy. The disclosure of the '526 Provisional Application is hereby incorporated by reference in its entirety.

A UWB multipath channel is given by

$$h ( t ) = {\sum }_{l = 1}^{L} {α}_{l} δ ( t - {τ}_{l} ) , \qquad ( 1 )$$

where L is the total number of MPCs, while a₁ and t₁ are the multipath gain coefficient and the TOA of the lth MPC, respectively. Based on (1), the signal r (t) received after the multipath channel is given by

$$r ( t ) = {\sum }_{l = 1}^{L} {α}_{l} p ( t - {τ}_{l} ) + n ( t ) , \qquad ( 2 )$$

where p(t) is the transmit signal pulse with duration Tₚ, while {a₁}ₗ₌₁^{L} and {t₁}ₗ₌₁^{L} are the received amplitudes and the TOAs of p(t), respectively, and n(t) is the additive white Gaussian noise (AWGN) with a zero mean and two-sided power spectral density N₀/2.

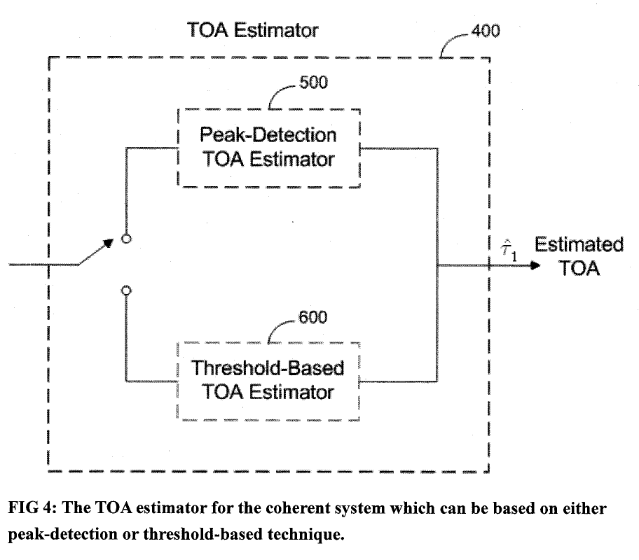

The parameter of interest for precision ranging is the TOA t₁ of the first arriving path, and not the strongest path tₘₐₓ. In a noisy and harsh environment, the first arriving path is usually weak and detection of such a weak signal in a dense multipath channel can be very challenging. FIG. 2 shows coherent system 200 for estimating the TOA based on match filter (MF), in accordance with one embodiment of the present invention. FIG. 3 shows non-coherent system 300 for estimating the TOA based on energy detector (ED), in accordance with one embodiment of the present invention. In coherent system 200, to estimate the TOA t₁ of the first arriving path, TOA estimator 400 can be based either on peak-detection TOA estimator 500 or threshold-based TOA estimator 600, as illustrated by FIG. 4.

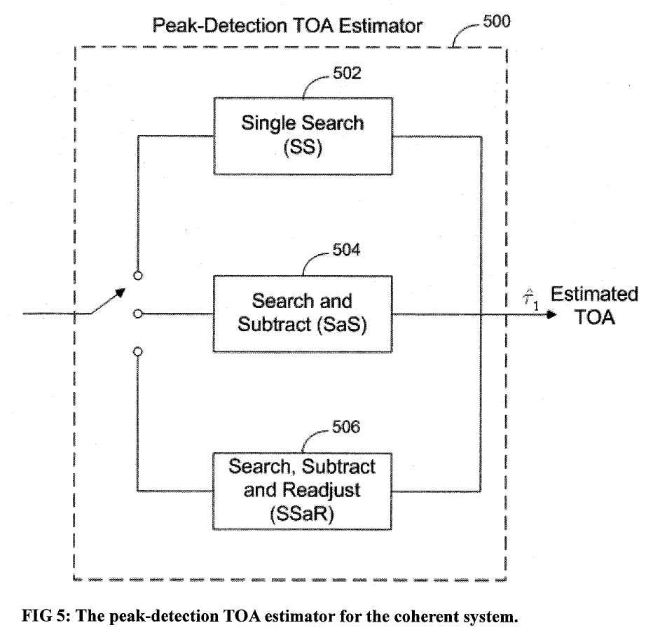

According to one embodiment of the present invention, the peak-detection TOA estimator 500 can be implemented using one of three estimation schemes. These schemes are, in increasing complexity, Single Search (SS) scheme 502, Search and Subtract (SaS) scheme 504, and Search, Subtract and Readjust (SSaR) scheme 506 illustrated, for example, in FIG. 5. Examples for these schemes are discussed in the article “Time of arrival estimation for UWB localizers in realistic environments,” by C. Falsi, D. Dardari, L. Mucchi, and M. Z. Win, EURASIP J. AppL Signal Processing, vol. 2006, pp. 1-13. All these algorithms detect the N largest values of the correlator output, where the N is the number of paths considered in the search, and determines the corresponding time locations tₖ_{₁}, tₖ_{₂}, . . . tₖ_{_{N.}}

Under SS scheme 502, the TOA and its amplitude are estimated with a single lock. First, the N largest peaks of the correlator output are found. Then, the minimum of the time locations {\hat{τ}ₖ_{ᵢ}}ᵢ₌₁^{N} is found. This minimum time location is set as the delay estimate of the TOA \hat{τ}₁ of the direct path.

SaS scheme 504 provides a method to detect MPC in a non-separable channel and is similar to the successive interference cancellation technique used in multiuser detection. Under SaS scheme 504, the sample vₖ_{₁} which corresponds to the largest peak of the correlator output is found. The index of sample vₖ_{₁} is then used to derive the corresponding time location, from which the delay estimate of the strongest path \hat{τ}ₖ_{₁} is obtained. As discussed above, the strongest path does not necessarily coincide with the first arriving path. Second, the delay estimate of the second strongest path \hat{τ}ₖ_{₂} is similarly found. This process is repeated until all N strongest paths are found. The minimum \hat{τ}₁ of time locations {\hat{τ}ₖ_{₁}}ᵢ₌₁^{N} is set as the estimate of the TOA of the direct path.

Unlike SaS scheme 504, under SSaR scheme 506, the amplitudes of all selected strongest paths are jointly estimated at each step. The same process is being repeated until the N strongest paths are found and then the minimum \hat{τ}₁ of time locations {\hat{τ}ₖ_{₁}}ᵢ₌₁^{N} is set as the estimate of the TOA of the direct path. While both SS scheme 502 and SaS scheme 504 estimate the delay and amplitude of each path separately in each step, SSaR scheme 506 estimate the amplitudes of different paths jointly.

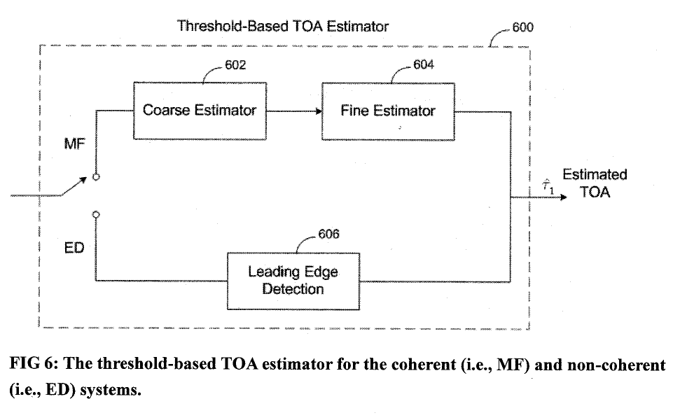

FIG. 6 illustrates threshold-based TOA estimator 600 suitable for implementing threshold-based TOA estimator for both the coherent and non-coherent systems, according to one embodiment of the present invention. Threshold-based TOA estimators suitable for implementing threshold-based TOA estimator 600 are discussed, for example, in the '526 Provisional Application. These threshold-based TOA estimators have low computational complexity requirements. For a coherent system with a MF (e.g., coherent system 200 of FIG. 2), the correlator output is compared to a threshold value 1. As shown in FIG. 6, coarse estimation 602 is first performed by detecting the first threshold crossing point \hat{τ}₁ to provide a coarse estimate for the TOA of the direct path. Then, fine estimation 604 searches for a peak within a pulse interval Tₚ in the vicinity of the coarse estimate. The peak location provides the final estimate \hat{τ}₁ of the TOA for the direct path.

For a non-coherent scheme with an ED (e.g., non-coherent TOA estimator 300), the TOA estimator performs a leading-edge detection to detect first threshold crossing point \hat{τ}₁.

In a threshold-based TOA estimator, selecting a suitable value for threshold 1 is important and may be difficult. For example, if threshold value 1 is set too low, a high false alarm probability may result from noise, thereby causing early TOA estimates. On the other hand, if threshold value 1 is set too high, a lower detection probability may result because of choosing a wrong path, thereby causing late TOA estimates. Furthermore, setting threshold value 1 too high may also result in a high missed detection probability (i.e., missing all paths), thereby yielding no TOA estimate. To avoid a missed detection, a missing path strategy such as the mid-point strategy or maximum-point strategy is usually used to find the TOA estimate \hat{τ}₁. Under such a strategy, an optimized threshold value 1ₒₚₜ is set by adopting the thresholding technique proposed in the '526 Provisional Application, which is incorporated by reference above. Under that technique, threshold value 1 is optimized according to the channel operating conditions (e.g., SNR, TX-RX separation distance, and LOS blockage).

Generally, TOA ranging error εᵣ may be defined as follows:

ε_{τ}=\hat{τ}₁−τ₁, (3)

where τ₁ is the TOA of the first arriving path, usually obtained based on the geometry of the measurement environment (e.g.,

$${τ}_{1} = \frac{d}{c} ,$$

where d is the actual separation distance between the TX and the RX, and c is the speed of light), and \hat{τ}ₗ is the estimated TOA of the first arriving path obtained using a peak-detection TOA estimator or a threshold-based TOA estimator, as discussed above.

Ranging error may result from, for example, multipath fading, SNR (or TX-RX separation distance), and NLOS propagation. The distance ranging error ε_{d} may be expressed explicitly as a function of the TX-RX separation distance d (or SNR) and system bandwidth w as follows:

ε_{d}(w,d)=εₘ(w,d)+εₙₗₒₛ(w,d), (4)

where εₘ ( ) and εₙₗₒₛ ( ) are the multipath error and the NLOS propagation error, respectively. Equation (4) shows that both system bandwidth w and the SNR are important parameters that affect the distance ranging error ε_{d}. Thus, according to one embodiment of the present invention, an optimum bandwidth selection method is proposed to reduce the ranging error.

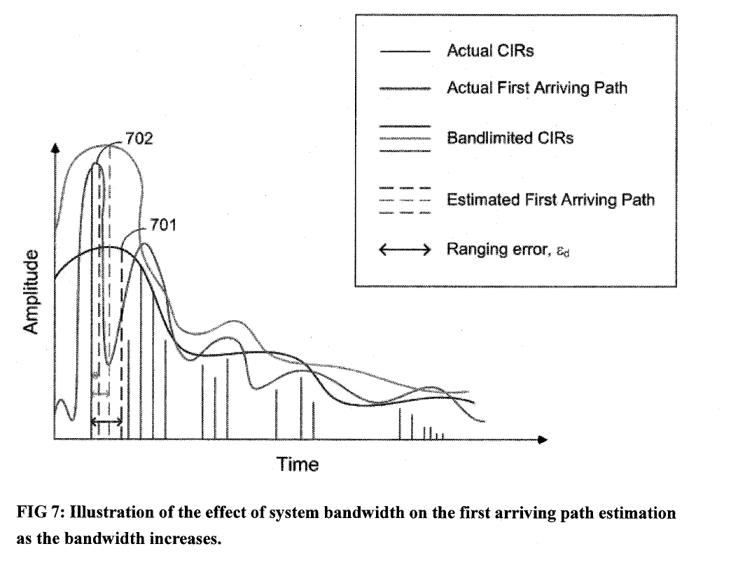

FIG. 7 illustrates the effects of both multipath dispersion and system bandwidth on the first arriving path estimation. In theory, increasing the bandwidth makes the channel impulse response closer to the ideal case and thus decreases the distance ranging error. As shown in FIG. 7, plot 701 has the smallest bandwidth, which results in the largest ranging error, while plot 702 has the largest bandwidth, which results in the smallest ranging error. However, in practice, increasing the bandwidth indefinitely does not necessarily reduce ranging error. Therefore, a method that selects an optimum operating bandwidth under certain SNR condition is essential.

Thus, system bandwidth w is a design parameter for which a careful choice plays an important role in optimizing a design for any TOA estimator.

Under an LOS condition, εₙₗₒₛ(w,d)=0 and thus ε_{d} (w,d)=εₘ(w,d). To study the effect of SNR on εₘ, the value of εₘ may be calculated with a fixed bandwidth. Under such a condition, the inventors have found that that εₘ is effectively constant over d (i.e., constant irrespective of the SNR values). Therefore, εₘ(w,d)≈εₘ (w) under a LOS condition.

The effect of bandwidth on the multipath error is next reviewed. To study the effect of bandwidth w on εₘ, the mean μ_{ε}_{ₘ}, bias σ_{ε}_{ₘ} and root-mean-square error (RMSE) RMSε_{ε}_{ₘ} of εₘ may be calculated as follows:

$$\begin{matrix}{μ}_{{ɛ}_{m}} = \frac{1}{N} {\sum }_{n = 1}^{N} {ɛ}_{m}^{( n )} , & ( 5 ) \\ {σ}_{{ɛ}_{m}} = \sqrt{\frac{1}{N} {\sum }_{n = 1}^{N} {( {ɛ}_{m}^{( n )} - {μ}_{{ɛ}_{m}} )}^{2}} , & ( 6 ) \\ {RMSE}_{{ɛ}_{m}} = \sqrt{{σ}_{{ɛ}_{m}}^{2} + {μ}_{{ɛ}_{m}}^{2}} , & ( 7 )\end{matrix}$$

for n=1, . . . N . To select an optimum bandwidth for the TOA estimators, the bias and RMSE are minimized. The inventors have found that the variation of mean μ_{ε}_{ₘ} with bandwidth w is independent of d, which further confirms that εₘ is independent of d. Furthermore, the absolute value of μ_{ε}_{ₘ} (i.e.|μ_{ε}_{ₘ}|) may be modeled by an exponential function ƒ(|μ_{ε}_{ₘ}|) given by

$$f ( \vert {μ}_{{ɛ}_{m}} \vert ) = {a}_{\vert {μ}_{{ɛ}_{m}} \vert} {e}^{{b}_{\vert {μ}_{{ɛ}_{m}} \vert} \vert {μ}_{{ɛ}_{m}} \vert} , \\ where {a}_{\vert {μ}_{{ɛ}_{m}} \vert} and {b}_{\vert {μ}_{{ɛ}_{m}} \vert} are the parameters for f ( \vert {μ}_{{ɛ}_{m}} \vert ) , \qquad ( 8 )$$

which may be estimated using a least squares method. Since, u_{ε}_{ₘ} is independent of d, a single parameter set is sufficient for ε_{d}. Thus, under a LOS condition, regardless of the SNR values, the optimum bandwidth for the TOA estimator is determined by the parameters

$${a}_{\vert {μ}_{{ɛ}_{m}} \vert} and {b}_{\vert {μ}_{{ɛ}_{m}} \vert} .$$

Because εₘ is independent of d, the distance ranging error under the NLOS condition can be simplified as follows:

ε_{d}(w,d)=εₘ(w)+εₙₗₒₛ(w,d) (9)

Since εₘ and εₙₗₒₛ are both present under an NLOS condition, they are inseparable. By assuming that the effect of w and d on εₙₗₒₛ are independent, equation (9) may be re-written as follows:

ε_{d}(w,d)=εₘ(w)+εₙₗₒₛ(w)+εₙₖₒₛ(d)=ε_{m,nlos}(w)+εₙₗₒₛ(d) (10)

where ε_{m,nlos}(w)=εₘ(W)+εₙₗₒₛ(W). To study the effect of d on εₙₗₒₛ, the value of ε_{d} may be calculated using a fixed bandwidth. Analysis shown that larger variations of εₙₗₒₛ (also ε_{d}) with different values of d. These variations are random and no correlation are observed between εₙₗₒₛ, and d. The variation of εₙₗₒₛ under an NLOS condition is mainly due to the positive bias introduce by different materials that block the LOS path (e.g., doors, walls, and furniture). The type of materials that block an LOS path affects the value of εₙₗₒₛ. Thus, NLOS propagation error may be presumed independent of d, but depends on the penetration coefficient, of the material that block the LOS path (i.e., εₙₗₒₛ(d)≈εₙₗₒₛX).

To study the effect of bandwidth w on ε_{d} (w,d), a similar approach as described above for an LOS condition may be adapted, in which the mean μₑ_{ₘ}_{,nlos}, bias σ_{ε}_{ₘ}_{,nlos}, and root-mean-square error (RMSE) RMSE_{ε}_{_{m,nlos}} of ε_{m,nlos} are calculated. Analysis showed that, despite the characteristics of ε_{m,nlos} is substantially different as compared to εₘ under an LOS condition, the exponential shape of εₘ are still present in ε_{m,nlos} in which the shape of the exponential function varies due to the NLOS propagation error. Thus, a different parameter set is required for each channel condition. Under an NLOS condition, regardless of the SNR values, an optimum bandwidth for the TOA estimator is determined by the parameters

$${a}_{\vert {μ}_{{ɛ}_{m}} \vert} , {b}_{\vert {μ}_{{ɛ}_{m}} \vert} and χ .$$

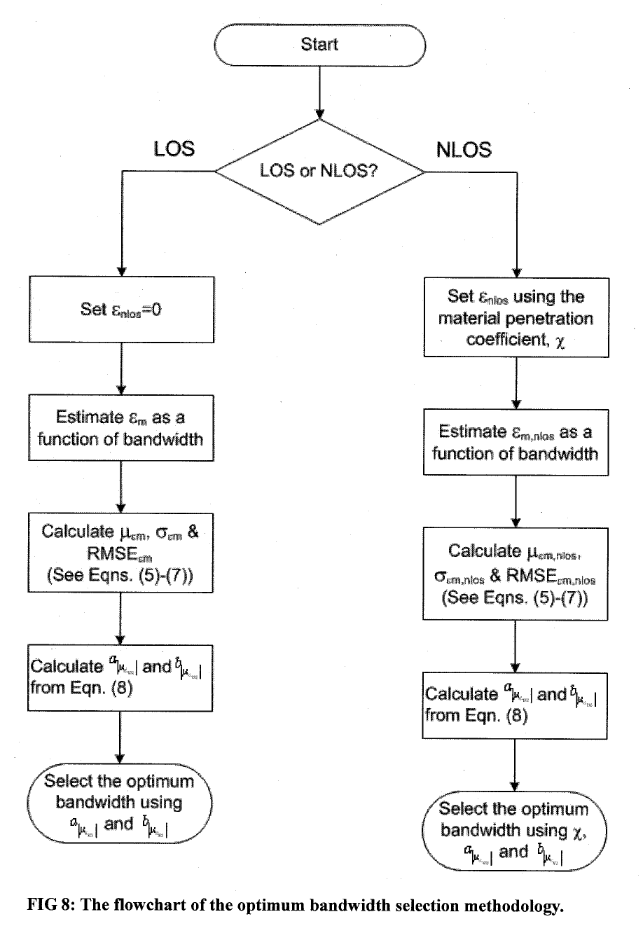

FIG. 8 shows flowchart 800 of a method for selecting an optimum bandwidth for both LOS and NLOS conditions. Flowchart 800 summarizes the bandwidth selection method discussed above with respect to the LOS and the NLOS conditions.

As shown above, ranging accuracy increases with bandwidth. However, the bandwidth gain, defined as the decrease in the ranging error with an increase in the bandwidth, diminishes with the measurement bandwidth. The decrease in ranging error (i.e., the bandwidth gain) is found greatest when the bandwidth increases from 500 MHz to 2.5 GHz and diminishes as the bandwidth is further increased, showing a non-linear relationship between bandwidth gain and bandwidth. If the bandwidth is large enough to identify the direct path from the multipath clutter, then any further increase in bandwidth does not provide an additional gain in the range resolution.

The above detailed description is provided to illustrate the specific embodiments of the present invention and is not intended to be limiting. Numerous variations and modifications within the scope of the present invention are possible. The present invention is set forth in the following claims.

We claim:

1. A method for reducing range error, comprising:
estimating the range errors as a function of bandwidth using a time-of-arrival (TOA) estimator;
from the estimated range errors, calculating a mean, a bias and a root-mean-square error of the range errors; and
selecting a bandwidth that minimizes the bias and the root-mean-square error.

2. A method as in claim 1, wherein selecting the bandwidth comprises:
deriving parameter values of a model of the mean of the range errors, using the calculated mean, the calculated bias and the calculated root-mean-square error; and
selecting the parameter values that minimize the bias and the root-mean-square error.

3. A method as in claim 1, further comprising:
determining whether or not a line-of-sight (LOS) condition is present in the channel; and
upon determining the LOS condition is present, calculating the mean, the bias and the root-mean-square error taking only multipath error into account.

4. A method as in claim 3 wherein, upon determining that the LOS condition is not present, estimating a non-line-of-sight (NLOS) component of the range error using a material penetration coefficient.

5. A method as in claim 4, wherein the range error is estimated using a multipath error and the NLOS component.

6. A method as in claim 1, wherein the TOA estimator is provided in a coherent system.

7. A method as in claim 6, wherein the TOA estimator comprises a peak-detection TOA estimator.

8. A method as in claim 7, wherein the peak-detection TOA estimator uses a peak-detection scheme selected from the group consisting of a single search scheme, a search and substract scheme and a search, subtract and readjust scheme.

9. A method as in claim 6, wherein the TOA estimator comprises a threshold-based TOA estimator.

10. A method as in claim 9, wherein the threshold-based TOA estimator comprises a coarse estimator, followed by a fine estimator.

11. A method as in claim 1, wherein the TOA estimator is provided in a non-coherent system.

12. A method as in claim 11, wherein the TOA estimator comprises a threshold-based TOA estimator.

13. A method as in claim 12, wherein the threshold-based TOA estimator comprises a lead edge detector.

14. A method as in claim 6, wherein the optimum bandwidth selected will always minimize the ranging error (i.e., bias and RMSE) irrespective of the SNRs under considerations.
